(19) United States
(12) Patent Application Publication
(10) Pub. No.: US 2019/0255644 A1
(43) Pub. Date: Aug. 22, 2019

(54) Wire Feeder with Automatically Adjustable Wire Clamping Force

(71) Applicant: The ESAB Group, Inc., Florence, SC (US)

(72) Inventors: David C. Griffin, Florence, SC (US); Dale T. Wiersema, Florence, SC (US); Michael Allen, Florence, SC (US)

(21) Appl. No.: 16/405,033

(22) Filed: May 7, 2019

Related U.S. Application Data
(63) Continuation of application No. PCT/US2016/063453, filed on Nov. 23, 2016.

(51) Int. Cl. B23K 9/133; B65H 51/32; B65H 51/10

(52) U.S. Cl. CPC B23K 9/1336; B65H 51/10; B65H 51/32; B23K 9/1333

(57) ABSTRACT

A wire feeder for a welding system has an automatically generated clamping force on welding wire. The wire feeder includes a drivestand having a lower feed roll. An upper feed roll is positionable adjacent to the lower roll, the upper and lower rolls being configured to receive a wire therebetween. A motor includes an output motor shaft, the lower roll being connected to the output motor shaft. A connecting arm is attached to the upper roll, and attached to the drivestand at a first end. An arm is attached to the connecting arm at a second end, and coupled to the motor. The arm and the connecting arm draw the upper roll towards the lower roll in response to a torque applied by the motor, such that the upper and lower rolls generate a clamping force for the wire, the clamping force being proportional to a torque of the motor.

### Cross-Reference to Related Applications

This application claims priority to and is a continuation of International Application PCT/US2016/063453, filed Nov. 23, 2016, entitled “WIRE FEEDER WITH AUTOMATICALLY ADJUSTABLE WIRE CLAMPING FORCE” the entire disclosure of which is incorporated herein by reference.

### FIELD OF THE DISCLOSURE

The disclosure generally relates to welding equipment, and more particularly to a wire feeder having an automatic wire clamping force feature.

### BACKGROUND OF THE DISCLOSURE

Wire feeders typically generate a clamping force between feed rolls by an adjustable loaded spring. The adjustment is manually achieved by a user, typically by turning a nut over a threaded rod, or a cam mechanism. The clamping force on the wire is defined by the manual adjustment of the spring, and the clamping force is adjusted to adjust the frictional forces between the feed roll surface and the wire so that wire slippage does not occur.

A problem with such manually adjusted clamping arrangements is that they rely on the user to appropriately adjust the spring mechanism. Inexperienced users can overtighten the spring mechanism, which can result in undesirable deformation of the wire, and in some cases, wire waste. Wear on the wire feed mechanism can also be accelerated when the manual adjustment feature is over-tightened by a user, since the mechanism will experience higher loading than is required in order to adequately feed the wire during operation.

In view of these and other problems, there is a need for a wire feed mechanism that provides a repeatably appropriate clamping force to a wire being fed therethrough, while minimizing or eliminating the chances for overtightening and related degradation of the wire or the feeding mechanism. It is with respect to these and other considerations that the present improvements may be useful.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

An exemplary embodiment of a wire feeder for a welding system in accordance with the present disclosure may include a drivestand including a lower feed roll and an upper feed roll selectively positionable adjacent to the lower feed roll. The upper feed roll and the lower feed roll may be configured to receive a wire therebetween. A motor may include an output motor shaft, and the lower feed roll may be rotatably connected to the output motor shaft. A connecting arm may be attached to the upper feed roll. The connecting arm may be fixedly attached to the drivestand at a first end and operable to selectively position the upper feed roll with respect to the lower feed roll. An arm may be pivotably attached to the connecting arm at a second end opposite from the first end. The arm may further be coupled to the motor. The arm and the connecting arm may be configured to draw the upper feed roll towards the lower feed roll in response to a torque being applied by the motor, such that the upper feed roll and the lower feed roll are configured to generate a clamping force for the wire. The clamping force may be proportional to a torque of the motor.

An exemplary embodiment of a method for operating a wire feeder for a welding system in accordance with the present disclosure may include: operating a motor including an output motor shaft, and feeding a wire between an upper feed roll and a lower feed roll. The upper feed roll may be selectively positionable adjacent to the lower feed roll. The lower feed roll may be connected to the output motor shaft. A connecting arm may be attached to the upper feed roll and may be pinned to a drivestand at a first end. The connecting arm may be operable to selectively position the upper feed roll with respect to the lower feed roll. The method may further include pivoting an arm between an open position and a clamped position, where the arm may be pivotably attached to the connecting arm at a second end opposite from the first end. The arm may be further coupled to the motor, and the method may further include applying a torque by the motor to the lower feed roll via the output motor shaft, and the upper feed roll via the arm and the connecting arm, and generating a clamping force by the arm and the connecting arm in response to the torque being applied by the motor, such that the upper feed roll is drawn towards to the lower feed roll. The clamping force may be proportional to a torque of the motor.

### BRIEF DESCRIPTION OF THE DRAWINGS

By way of example, a specific embodiment of the disclosed device will not be described, with reference to the accompanying drawings, in which:

FIG. 1 is a perspective view illustrating an embodiment of a wire feeder in accordance with the present disclosure in a clamped position;

FIG. 1A is a front view illustrating an embodiment of the wire feeder shown in FIG. 1 in a clamped position

FIG. 2 is a perspective view illustrating an embodiment of the wire feeder shown in FIG. 1 in an unclamped position;

FIGS. 3A, 3B are perspective views illustrating an embodiment of the motor assembly of the wire feeder shown in FIG. 1;

FIGS. 4A-4C are first and second side views and a perspective view of an arm portion of the wire feeder shown in FIG. 1;

FIGS. 5A-5E illustrate a side view and a plurality of perspective views of a connecting arm portion of the wire feeder shown in FIG. 1;

FIGS. 6A-6D illustrate a plurality of side and perspective views of a drivestand portion and feed rolls of the wire feeder shown in FIG. 1;

FIGS. 7A is a side view illustrating an embodiment of the drivestand portion, feed rolls, and connecting arm portion of the wire feeder in a clamped position shown in FIG. 1;

FIG. 7B is a front view illustrating an embodiment of the drivestand portion, feed rolls, and connecting arm portion of the wire feeder in an unclamped position in FIG. 2;

FIGS. 8A-8C are front views illustrating an embodiment of a portion of the feed roll of the wire feeder shown in FIG. 1; and

FIG. 9 is a flow diagram of a method of operating a wire feeder according to the present disclosure.

### DETAILED DESCRIPTION

The present embodiments will now be described more fully hereinafter with reference to the accompanying drawings, in which several exemplary embodiments are shown. The subject matter of the present disclosure, however, may be embodied in many different forms and should not be construed as limited to the embodiments set forth herein. Rather, these embodiments are provided so that this disclosure will be thorough and complete, and willfully convey the scope of the subject matter to those skilled in the art. In the drawings, like numbers refer to like elements throughout.

The present disclosure relates to a wire feeder assembly that is capable of providing an automatically adjustable wire clamping force that can eliminate problems of prior wire feed arrangements that require the clamping force to be manually adjusted by the user. As mentioned, manual adjustment of wire clamping force relies on the skill of the user to adjust the clamping mechanism to provide sufficient clamping force to drive the wire, but not to provide so much force that the wire is deformed or damaged. The presently disclosed arrangement includes a feature in which the wire clamping force is automatically adjusted based on the torque of the motor. For example, the motor may be mounted so that torque generated by the motor is applied to a linkage that transmits an associated force to the upper feed roll. As the motor torque increases, the clamping force automatically increases to provide sufficient force to prevent wire slippage, but not so much force that the wire is damaged. The disclosed arrangement thus eliminates the user-adjustment aspect of prior arrangements, and can result in an optimized provision of clamping force during wire feeder operation.

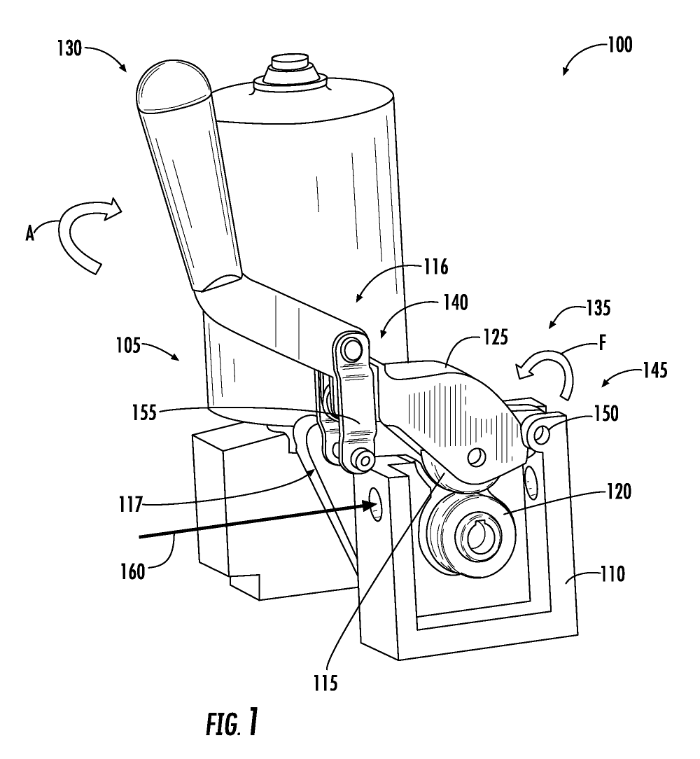

Referring now to FIG. 1, a perspective view of a wire feeder 100 for a welding system consistent with a non-limiting, exemplary embodiment of the present disclosure is shown. The wire feeder 100 may include a motor assembly 105, a drivestand 110, an upper feed roll 115, and a lower feed roll 120. A connecting arm 125 may be rotatably coupled to the drivestand 110 at a drivestand pivot point 145 disposed at a first end 135 of the connecting arm 125. The connecting arm 125 and drivestand 110 may be joined by any appropriate arrangement that permits rotational movement between the connecting arm 125 and the drivestand 110. In the illustrated embodiment the connecting arm 125 may be rotatably coupled to the drivestand 110 at the drivestand pivot point 145 by a pin connection 150 so that the rotational axis of the connecting arm is parallel to the rotational axes of the upper and lower feed rolls 115, 120.

In practical application, the drivestand 110 itself will be coupled to a fixed portion of a wire feeder housing (not shown), as will be appreciated by one of ordinary skill in the art.

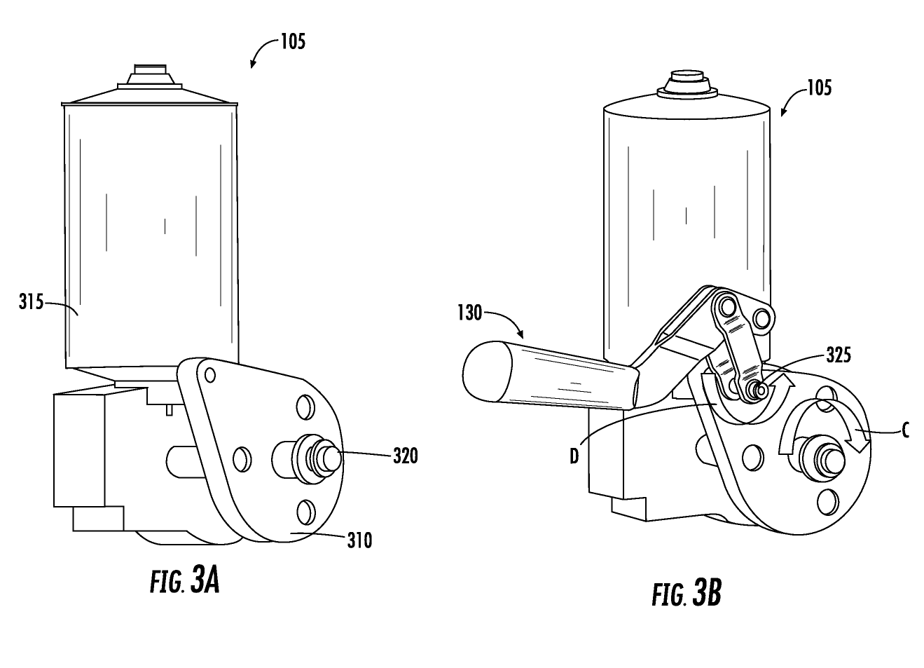

The upper feed roll 115 may be rotatably coupled to the connecting arm 125, while the lower feed roll 120 may be coupled to an output shaft 320 (FIG. 3A) of a motor assembly 105. Thus arranged, when welding wire (not shown) is fed between the lower feed roll 120 and the upper feed roll 115, the feed rolls can rotate to engage the welding wire, thereby moving the wire in a desired direction.

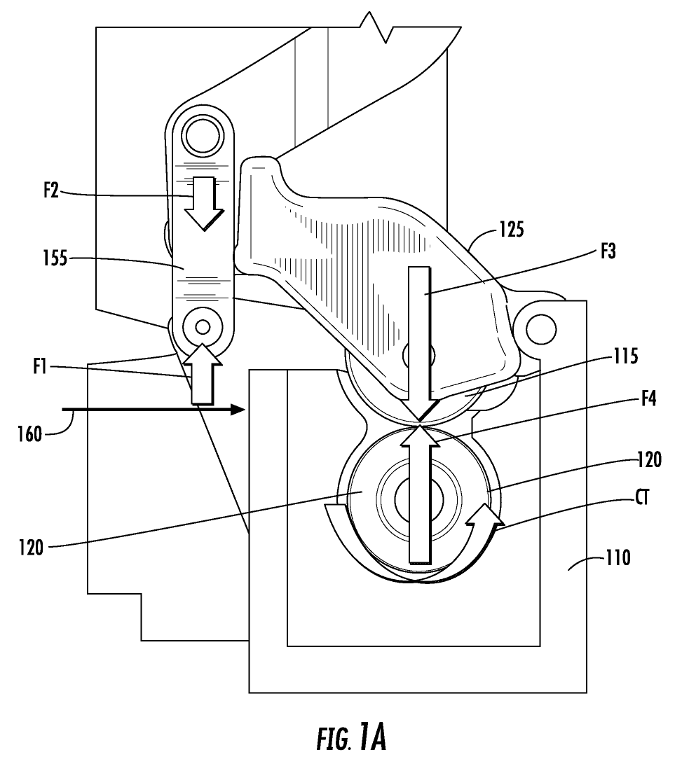

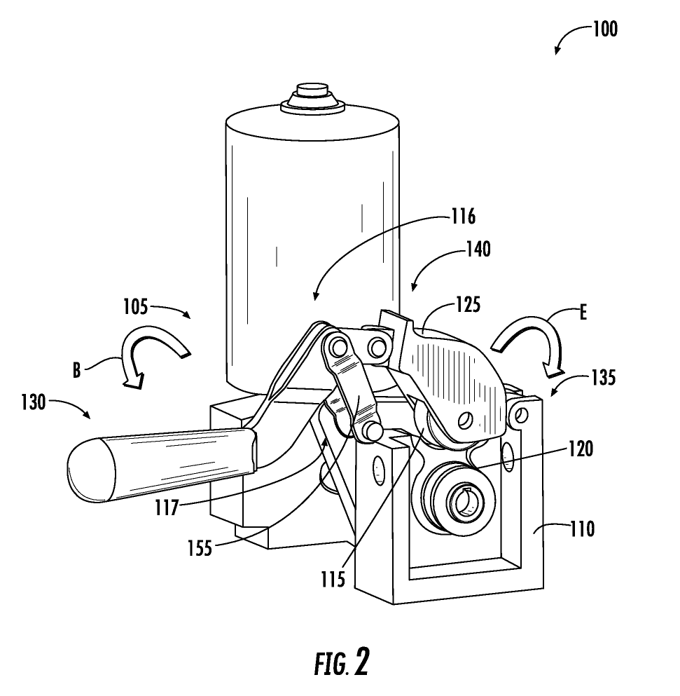

When the connecting arm 125 is rotated relative to the drivestand 110 about the drivestand pivot point 145, the upper feed roll 115 moves with the connecting arm 125. In this way the upper feed roll 115 can be moved toward or away from the lower feed roll as the connecting arm 125 rotates about the drivestand pivot point 145. This rotation allows for a welding wire to be initially threaded between the feed rolls 115, 120, and also provides for subsequent adjustability of a clamping force exerted on the wire between the upper feed roll 115 and the lower feed roll 120, as will be described in greater detail below. FIG. 1 shows an embodiment of the wire feeder 100 in a clamped position (i.e., the upper feed roll 115 is directly adjacent the lower feed roll 120), while FIG. 2 shows an embodiment of the wire feeder 100 in an open, unclamped, position (i.e., the upper feed roll 115 is swung away from the lower feed roll 120).

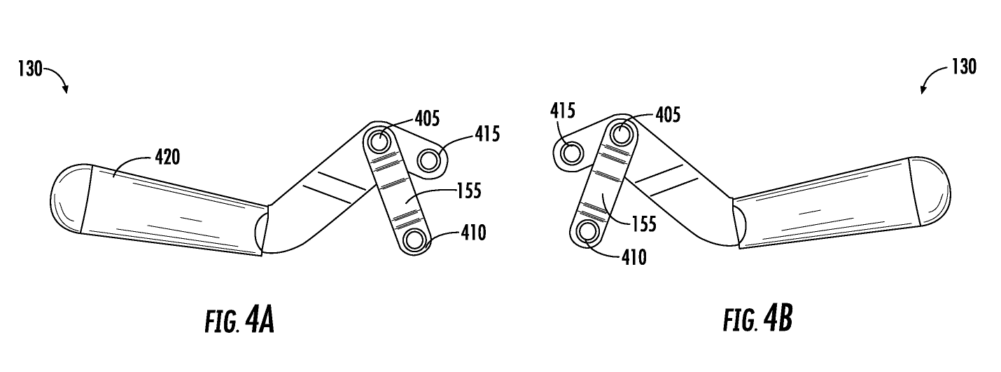

The connecting arm 125 may be pivotably coupled at a second end 140 to an arm 130 so that the arm may be used to position the connecting arm 125 (and the upper feed roll 115) with respect to the lower feed roll 120. The arm 130 may be any type of connection to position the upper feed roll 115, including but not limited to a latch, a strap, a removable pin, and a toggle. The arm 130 may also be joined to a motor mount 310 (FIGS. 3A, 3B) of the motor assembly 105 via a linkage 155. The linkage 155 functions as a pivoting linkage that, as will be described in greater detail below, allows force to be variably applied to the upper feed roll 115. The linkage 155 can be coupled at a first end 116 to the arm 130 at a first pivot point 405 (FIGS. 4A, 4B) and can be coupled at a second end 117 to the motor mount 310 at a second pivot point 410 (FIGS. 4A, 4B) by a pin 325. The arm 130 and the linkage 155 may adjust during operation so that uniform clamping force is provided. For example, the arm 130 and the linkage 155 may shift during use due to fit of the components, e.g., in the event of the feed rolls 115, 120 being out of round.

FIGS. 3A, 3B further show that the motor assembly 105 may include a motor 315, a motor mount 310, and an output motor shaft 320. In the illustrated embodiment the output motor shaft 320 passes through an opening of the drivestand 110 and couples to the lower feed roll 120 so that the lower feed roll rotates with the output motor shaft.

Referring to FIGS. 4A-4C, the arm 130 is shown coupled to the linkage 155 at the first pivot point 405. The arm 130 is coupleable to the connecting arm 125 at the third pivot point 415 (FIG. 1). Thus arranged, the linkage 155 is pivotably coupleable to the arm 130 at the first pivot point 405, and is pivotably coupleable to the motor mount 310 at the second pivot point 410. The linkage 155 may be held in tension between the first pivot point 405 and the second pivot point 415 so the arm 130 may position the upper feed roll via the connecting arm 125. The arm 130 may be removably connectable to and/or extendable from the linkage 155. The first pivot point 405 and the second pivot point 410 may each include an aperture and pin for pivotably attaching the respective elements to each other. It will be appreciated that the aperture and pin arrangement is merely exemplary, and that other pivot mechanisms can also be used without departing from the disclosure.

The arm 130 may include a handle portion 420, disposed at an end opposite of the first, second, and third pivot points 405, 410, and 415.

As shown in FIG. 4C, and as previously mentioned, the linkage 155 may be pivotably coupled at each end 116, 117 via the first and second pivot points 405, 410. Thus arranged, the linkage 155 may constrain and guide movement of the arm 130, which in turn can constrain and guide movement of the connecting arm 125 and the upper feed roll 115. The connecting arm 125 is similarly constrained and guided with respect to the drivestand via drivestand pivot point 145.

In one embodiment, rotating the arm 130 in a first direction (identified by arrow “A”) causes the upper feed roll 115 to move toward the lower feed roll 120 to assume the position illustrated in FIG. 1, while rotating the arm in a second direction (identified by arrow “B”) causes the upper feed roll to move away from the lower feed roll to assume the position illustrated in FIG. 2.

Referring to FIG. 2, wire feeder 100 is shown in an unclamped position. As can be seen, moving the arm 130 in the direction of arrow “B” configures the arm in the unclamped position. As the arm 130 is pivoted at the second end 140 of the connecting arm 125, the connecting arm 125 is rotated at the first end 135 in the direction of arrow “E,” moving the upper feed roll 115 away from the lower feed roll 120. The connecting arm 125 is constrained at the second end 140 by the first pivot point 405 coupling the linkage 155 and the arm 130, the second pivot point 410 coupling to the motor mount 310, and the third pivot point 415 coupling to the connecting arm 125. The connecting arm 125 is constrained at the first end 135 between the drivestand 110 and the connecting arm 125.

Referring to FIG. 1, wire feeder 100 is shown in a clamped position. Moving arm 130 in the direction of arrow “A” configures the arm in the clamped position. As the arm 130 is pivoted at the second end 140 of the connecting arm 125, the connecting arm 125 is rotated at the first end 135 in the direction of arrow “F,” moving the upper feed roll 115 toward the lower feed roll 120. The connecting arm 125 remains constrained at the second end 140 by the first pivot point 405 coupling the linkage 155 and the arm 130, the second pivot point 410 coupling to the motor mount 310, and the third pivot point 415 coupling to the connecting arm 125. The connecting arm 125 is constrained at the first end 135 between the drivestand 110 and the connecting arm 125.

As can be seen, the motor 105 is indirectly coupled to the drivestand 110 via a plurality of additional elements. In the illustrated embodiment the motor 105 is coupled to the motor mount 310 which is rotatably coupled to the linkage 155. The linkage 155, in turn, is rotatably coupled to the arm 130, which is rotatably coupled to the connecting arm 125. The output motor shaft 320 is coupled to the lower feed roll 120, such that when the motor 105 rotates (to rotate the lower feed roll 120), an equal and opposite torque tends to rotate the motor in a direction opposite that of the output motor shaft 320. This opposite rotation is limited by the clamping force applied between the upper feed roll 115 and the lower feed roll 120 via the wire. This opposite rotational tendency results in a tension being applied by the motor mount 310 to the connecting link 155 via the second pivot point 410. This force, in turn, is applied to the connecting 125 arm via the pivot point 140 and 415.

Referring to FIG. 1A, rotation of the motor mount 310 is limited by balancing various forces and torque. As a wire (not shown) is fed through the wire feeder 100 indicated by the arrow 160, the lower feed roll 115 rotates in a clockwise direction. The wire imparts a counter torque, indicated by arrow “CT” in a counterclockwise direction, which will turn the upper feed roll 115 counterclockwise. This counter torque CT around the motor output shaft 320 is balanced by an upward force indicated at arrow “F1” at the pin 325 of the motor mount 310 at the second pivot point 410 of the linkage 155. As mentioned, the linkage 155 is held in tension and coupled to the arm 130, the arm 130 also be coupled to the connecting arm 125 at the third pivot point 415. A downward force indicated by arrow “F2” through the arm 130 and linkage 155 at the third pivot point 415 is applied to the upper feed roll 115 via the connecting arm 125. F2 may be in a direction opposite of F1 and of a similar magnitude. The connecting arm 125 may act as a lever for positioning the upper feed roll 115, amplifying the F1 and F2 forces from the linkage 155 and arm 130 to generate a larger force, indicated at arrow “F3.” F3 is a larger force than F1 and F2, which is indicated by a larger arrow in FIG. 1A. A reaction force from the wire clamping is indicated by arrow “F4.” F4 may be in a direction opposite of F3 and of a similar magnitude, with that F4 being in line with the motor output shaft 320 such that the torque balance remains unaffected.

Referring again to FIGS. 3A, 3B, the arm 130 is coupled to the motor mount 310 at the second pivot point 410. As mentioned, during operation, the motor 305 rotates the motor output shaft 320 in a first direction indicated at arrow “C,” and torque is applied in an opposite direction to the arm 130 via the motor mount 310 in a second direction indicated at arrow “D.” This torque results in a force being applied to the connecting arm 125 which tends to rotate the connecting arm in a counterclockwise direction. In the illustrated embodiment rotation of the output motor shaft 320 results in the lower feed roll 120 rotating in a clockwise direction, which will cause a wire fed between the upper and lower feed rolls to move from left to right.

When the wire is fed through the drivestand 110 to the upper feed roll 115 and the lower feed roll 120, a torque is imparted to the motor assembly 105. Force from the torque is also applied via the first pivot point 405 and the motor mount 310 to the connecting arm 125 and upper feed roll 115. This force draws the upper feed roll 115 toward the lower feed roll 120, clamping the wire therebetween. The clamping force is a function of the torque applied by the motor assembly 105. For example, when the motor speed increases, the rotational speed of the lower feed roll 120 increases to feed the wire through the system at a faster rate. At the same time, if the torque applied to arm 130 via the motor mount 310 increases, this results in a greater clamping force being applied by the upper feed roll 115 via the connecting arm 125 and arm 130. The clamping force applied by the upper feed roll 115 to the wire is thus automatically adjusted as the torque of the motor changes. Thus, the clamping force is proportional to a torque of the motor. This eliminates the need for a user to manually adjust the clamping force for different operating conditions.

Geometries of the components of the system 100 can be selected using traditional frictional force and geometry calculations. In one non-limiting exemplary embodiment, it is assumed that there is no slip between the wire and the upper and lower feed rolls 115, 120, such that the static friction formula (Fs=gn) applies. In the instant application Fs is friction available in the direction of wire travel 160 at the interface between the wire and the upper and lower feed rolls 115, 120 just before wire slippage. μ is the coefficient of static friction, which may be assumed to be approximately constant. Fₙ is the normal force, which, with respect to the wire feeder 100, can be the clamping force. The clamping force is applied by the upper feed roll 115 and the lower feed roll 120 to the wire therebetween, normal to the axis of the direction of wire travel 160. The benefit of this arrangement is that the normal, or clamping, force only needs to generate enough static friction between the wire and the feed rolls to overcome resistance applied to the wire through welding torch components, for example, a torch liner, a contact tip, and/or a spool brake (not shown). This resistance can be related to the torque applied by the motor 310. The geometry of the first, second, and third pivot points 405, 410, 415, a center of gravity of the motor 105 and its related components, and the selection of a non-adjustable spring can be adjusted to define a desired relationship between motor torque and clamping force. These variables can be adjusted and optimized across a wide variety of applications.

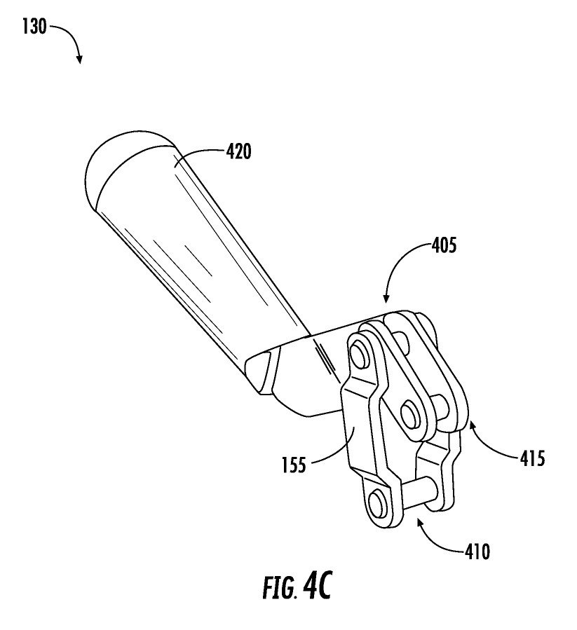

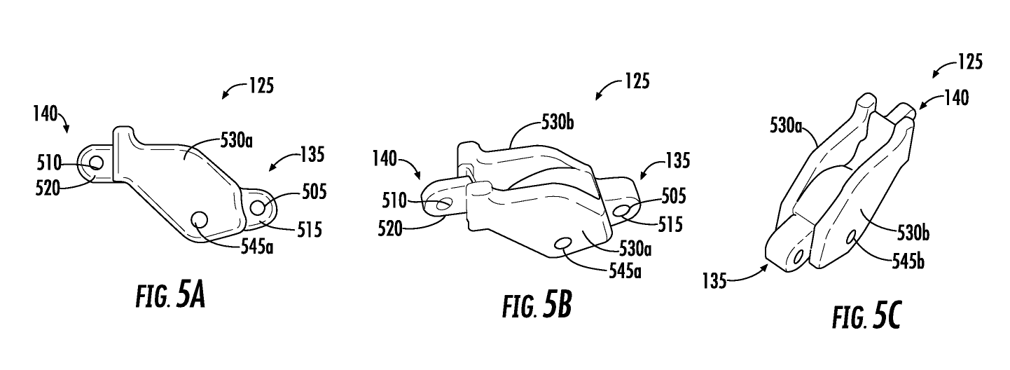

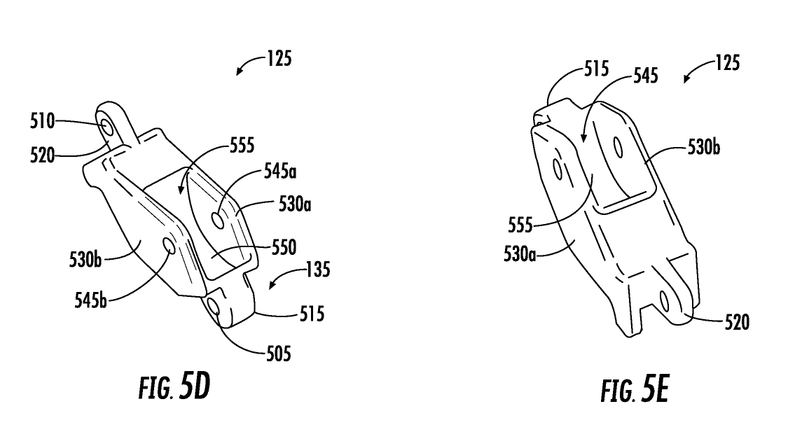

Referring now to FIGS. 5A-5E, an embodiment of the connecting arm 125 is depicted in accordance with the present invention. The connecting arm 125 may have first and second ends 135, 140, and may be configured to connect to the drivestand 110 at the first end 135 and the arm 130 at the second end 540. The shape of the connecting arm 125 may accommodate for an offset of the drivestand 110 and the arm 130. A first aperture 505 may be disposed in a first flange 515 at the first end 135, and second aperture 510 may be disposed in a second flange 520 at the first end. As more fully described below, the connecting arm 125 may be rotatably connected to the drivestand 110 by coupling the first flange 515 and the first aperture 505 of the connecting arm 125 to the drivestand 110. In the illustrated embodiment this coupling is achieved via a pin disposed in the aperture 505, although other pivoting mechanisms can be used.

The second aperture 510 in the second flange 520 may be disposed at the second end 140 of the connecting arm 125. The second aperture 510 may align with the third pivot point 415 of the arm 130, as described above with respect to FIGS. 4A-4C. The third pivot point 415 may include an aperture to receive a pin or other joining mechanism (not shown). The third pivot point 415 may be disposed at the second end 140 of the arm 130, adjacent to the linkage 155. The second aperture 510 may therefore be coaxial to the third pivot point 415 when the connecting arm 125 is coupled to the arm 130.

As described above, the upper feed roll 115 may be rotatably connected to the connecting arm 125. The upper feed roll 115 may be coupled to the connecting arm 125 via a third aperture 545a on a first side 530a of the connecting arm and a fourth aperture 545b on a second side 530b of the connecting arm. The third aperture 545a and the fourth aperture 545b are aligned and coaxial on the respective first side 530a and second side 530b. As more clearly shown in FIGS. 5D and 5E, a pocket 555 is formed between the first side 530a and the second side 530b, which may receive the upper feed roll 115. The upper feed roll 115 may be disposed in the pocket 555 and rotatably coupled to the connecting arm 125 via a pin or other joining mechanism (not shown) disposed in the third aperture 125 and the fourth aperture 545b.

The first side 530a and the second side 530b of the connecting arm 125 may be joined by a surface 550, to thereby form the pocket 555. The surface 550 may be curved to be larger than the diameter of the upper feed roll 115, such that the upper feed roll 115 is free to rotate without interfering with the connecting arm 125.

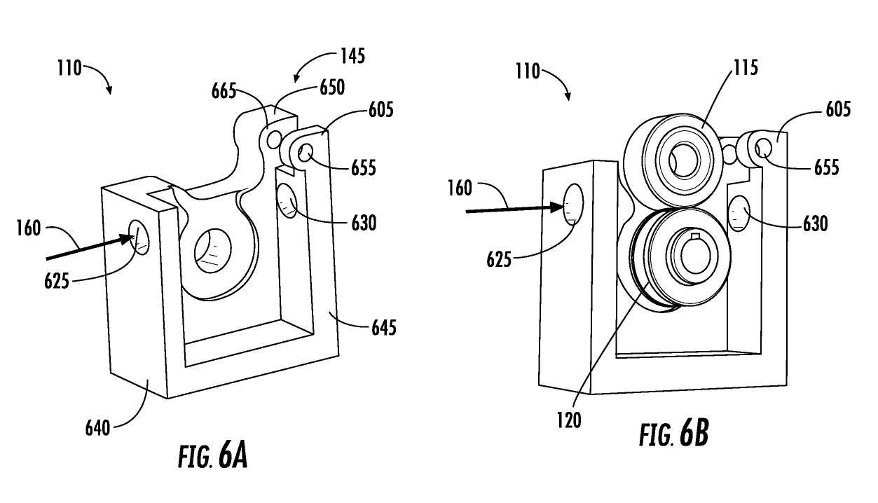

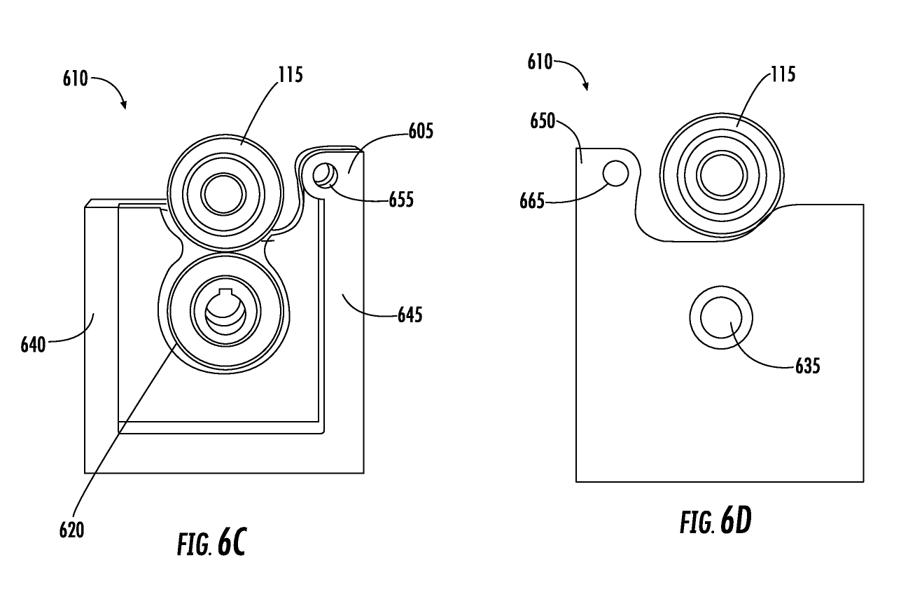

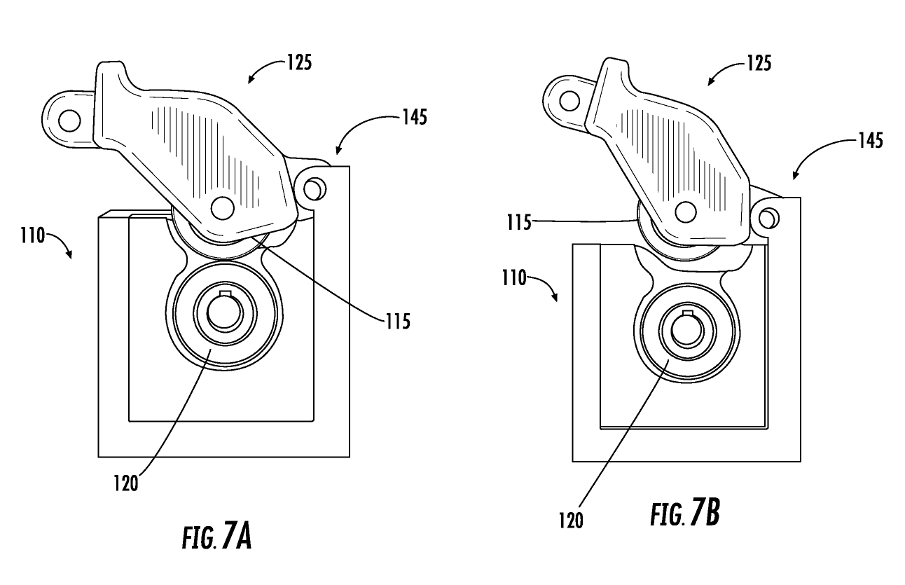

Referring now to FIGS. 6A-6D, an embodiment of the drivestand 110, including the upper feed roll 115 and the lower feed roll 120 in FIGS. 6B-6G, are depicted. As described above, the connecting arm 125 may be rotatably connected to the drivestand 110 by coupling the drivestand pivot point 145 and the first aperture 505 of the connecting arm 125. The drivestand 110 may include a front side flange 605 and a rear side flange 650 at the drivestand pivot point 145. The front side flange 605 includes a first drivestand aperture 655, and the rear side flange 650 includes a second drivestand aperture 665. The first and second drivestand apertures 655, 665 may be aligned and coaxial with each other. A pin or other joining mechanism (not shown) may extend through the drivestand apertures 655, 665 of the flanges 605, 650 and through the first aperture 505 of the connecting arm 125 so as to rotatably couple the connecting arm 125 to the drivestand 110.

The illustrated drivestand 110 is approximately rectangular in shape, though this is not critical and the drivestand may have any shape that allows it to be fixedly coupled to the welding system. In an embodiment, the drivestand 110 may be a frame. The drivestand 110 may be fixedly coupled to a wire feeder system (not shown), such that the drivestand 110 is stationary with respect to the wire feeder system. As described above, the output motor shaft 310 extends through an opening 635 in the drivestand 110 where it couples to the lower feed roll 120. The opening 635 may include a bearing for receiving the motor output shaft 320.

The drivestand 110 may further include a wire inlet 625 and a wire outlet 630 on opposing sides 640, 645 of the drivestand 110, 610. The wire inlet 625 may be disposed on a first drivestand side 640, and the wire outlet 630 may be disposed on a second drivestand side 645. The front side flange 605 and the rear side flange 610 may also be disposed on the second drivestand side 645, such that the first end 135 of the connecting arm 125 is rotatably connected to the drivestand 110 at the second drivestand side 645. The welding wire may be fed in the direction 160, and may be drawn in that direction by the lower feed roll 120 rotating in a clockwise direction, and the upper feed roll 115 rotating in a counterclockwise direction.

As mentioned, rotation of the output motor shaft 320 causes the lower feed roll 120 to rotate with respect to the stationary drivestand 110. The upper feed roll 115 is selectively positionable with respect to the lower feed roll 120 via the connecting arm 125 and arm 130. The connecting arm 125 is rotatable with respect to the drivestand 110 at the drivestand pivot point 145 when the arm 130 is pivoted via the first, second, and third pivot points 405, 410, 415. These first, second, third pivot points 405, 410, 415, as well as the drivestand pivot point 145, enable the connecting arm 125, and thus, the upper feed roll 115, to be movable toward, and away from, respect to the lower feed roll 120.

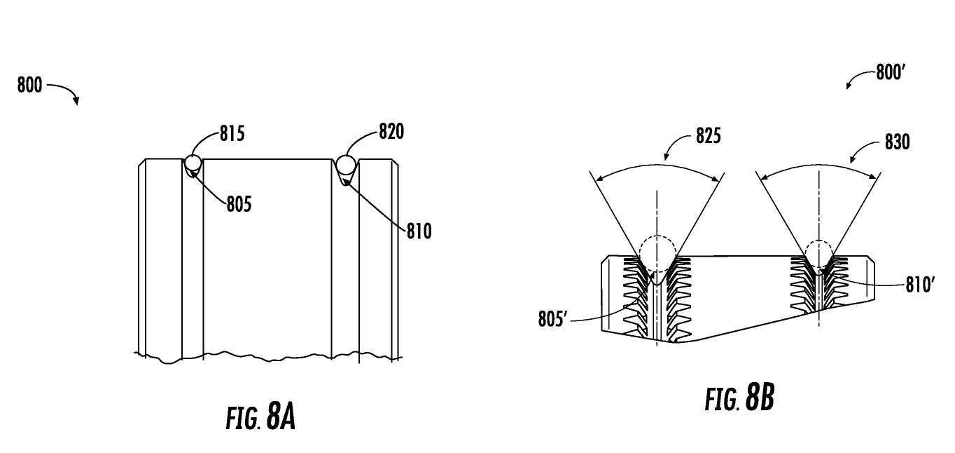

Referring to FIGS. 7A, 7B, a wire may be fed between the upper feed roll 115 and the lower feed roll 120 when the two are in the unclamped position (FIG. 7B). The upper feed roll 115 may then be moved towards the lower feed roll 120 to impart a clamping force on the wire in the clamped position (FIG. 7A). Thereafter, when force is applied to the connecting arm 125 tending to move the upper feed roll 115 toward the lower feed roll, a clamping force on the wire is increased. When the force applied to the connecting arm 125 is reduced, the clamping force on the wire is decreased. As described above, with the disclosed arrangement the force applied to the connecting arm 125 is proportional to the torque of the motor. Thus, as the motor torque increases (as a result of things like debris in the torch, bending in the torch cable, length of the torch, or an increase in motor speed), force applied to the connecting arm 125 via the arm 130 increases, which causes the clamping force applied to the upper feed roll to increase. Conversely, as the motor torque decreases, force applied to the connecting arm 125 via the arm 130 decreases, which causes the clamping force applied to the upper feed roll to decrease.

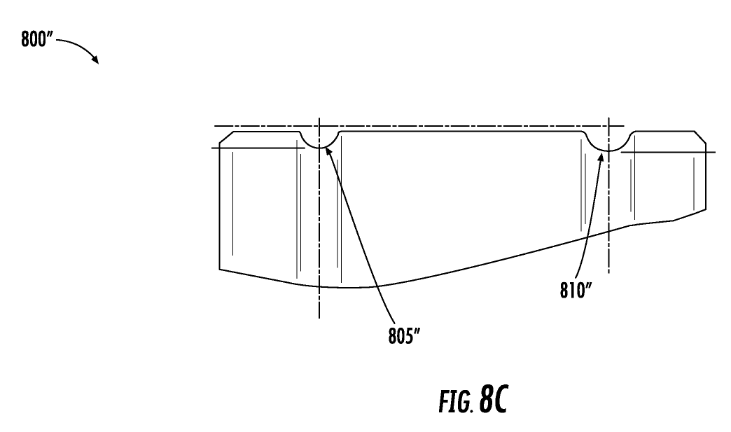

Referring to FIGS. 8A-8C, embodiments of a feed roll 800 are shown. The feed roll 800 may include one or more grooves 805, 810, 805′, 810′, 805″, 810″ configured for receiving a wire 815, 820. For example, referring back to FIGS. 1 and 2, the lower feed roll 120 may include one or more grooves. The upper feed roll 115 may include grooves, or may be a flat surface as shown in FIGS. 1 and 2.

The grooves in the lower feed roll 115 may include a diameter approximately matching a diameter of the welding wire to be used. The grooves may have an opening angle 825, 830 which may be a function of the clamping force of the wire. For example, a feed roll 120 may have a groove 805, 810 with a desired opening angle 825, 830 and geometry for a particular clamping force. For example, the grooves 805, 810 may be a v-shape as shown in FIG. 8A. The grooves 805″, 810″ may be a u-shape. In some embodiments, the grooves 805′, 810′ may include a knurl or serrated edge and a shallower angle, forming a k-shape, as shown in FIG. 8B.

In an embodiment, the upper feed roll 115 and/or the lower feed roll 120 may be removable and replaceable in the wire feeder 100, such that the upper feed roll 115 and the lower feed roll 120 are exchangeable based on a desired welding wire to be used. This permits the wire feeder 100 to be adaptable to various welding systems that use a variety of welding wire thicknesses.

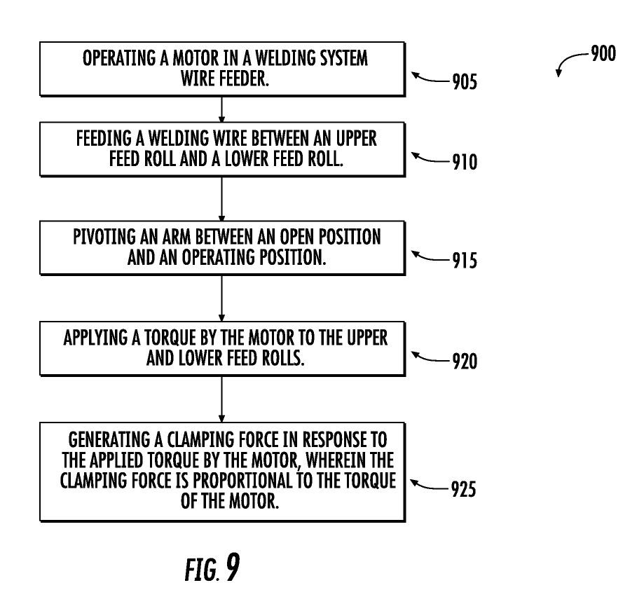

FIG. 9 depicts a flow diagram 900 of a method of operating a wire feeder according to an embodiment of the present invention. At 905, a wire feeder in a welding system is operating a motor 105, including an output motor shaft 320. At 910, a welding wire is fed between an upper feed roll 115 and a lower feed roll 120. The upper feed roll 115 is selectively positionable adjacent to the lower feed roll 120, the lower feed 120 roll being connected to the output motor shaft 320. A connecting arm 125 is attached to the upper feed roll 115 and pinned to a drivestand 110 at a first end 135, the connecting arm 125 being operable to selectively position the upper feed roll 115 with respect to the lower feed roll 120.

At step 915, an arm 130 is pivoted between an open position and a clamped position. The arm 130 is pivotably attached to the connecting arm 125 at a second end 140 opposite from the first end 135, the arm 130 being further coupled to the motor 105. At step 920, a torque is applied by the motor 105 directly to the lower feed roll 120 via the output motor shaft 320, and a force proportional to the motor torque is applied to the upper feed roll 115 via the arm 130 and the connecting arm 125.

The motor torque applied at 920 results in a clamping force at step 925, in response to the applied torque by the motor 105. The clamping force is proportional to a torque of the motor 105. When the motor torque is increased, the upper feed roll 115 is pressed toward the lower feed roll 120, increasing the clamping force on the wire fed therebetween. Conversely, when the motor torque is decreased, the force of upper feed roll 115 against the wire is decreased.

As used herein, an element or operation recited in the singular and proceeded with the word “a” or “an” should be understood as not excluding plural elements or operations, unless such exclusion is explicitly recited. Furthermore, references to “one embodiment” of the present disclosure are not intended to be interpreted as excluding the existence of additional embodiments that also incorporate the recited features.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A wire feeder for a welding system, comprising:
a drivestand including a lower feed roll;
an upper feed roll selectively positionable adjacent to the lower feed roll, the upper feed roll and the lower feed roll being configured to receive a wire therebetween;
a motor including an output motor shaft, the lower feed roll being rotatably connected to the output motor shaft;
a connecting arm attached to the upper feed roll, the connecting arm being rotatably attached to the drivestand at a first end, the connecting arm operable to selectively position the upper feed roll with respect to the lower feed roll;
an arm pivotably attached to the connecting arm at a second end opposite from the first end, the arm further coupled to the motor;
wherein the arm and the connecting arm are configured to draw the upper feed roll towards the lower feed roll in response to a torque being applied by the motor, such that the upper feed roll and the lower feed roll are configured to generate a clamping force for the wire; and
wherein the clamping force is proportional to a torque of the motor.

2. The wire feeder according to claim 1, wherein the clamping force is automatically generated by the torque, in response to overcoming friction resistance of the wire in the welding system.

3. The wire feeder according to claim 2, wherein the clamping force automatically generated by the torque provides a force on the wire being fed through the system.

4. The wire feeder according to claim 1, wherein in an open position the connecting arm at the second end is rotated to a position via movement of the arm, such that the upper feed roll is separated from the lower feed roll.

5. The wire feeder according to claim 1, further comprising a linkage rotationally coupled to the arm at a first pivot point, and a motor mount of the motor at a second pivot point, and held in tension between the arm and the connecting arm.

6. The wire feeder according to claim 5, wherein the arm is rotatably coupled to the connecting arm at a third pivot point, such that movement of the connecting arm is constrained by the first, second, and third pivot points.

7. The wire feeder according to claim 1, wherein the connecting arm is rotatably coupled to the drivestand at a drivestand pivot point.

8. The wire feeder according to claim 6, wherein the connecting arm is rotatably coupled to the drivestand at a drivestand pivot point, such that the movement of the connecting arm is further constrained by the drivestand pivot point.

9. The wire feeder according to claim 1, wherein the connecting arm includes a first side, a second side, and a surface therebetween, forming a pocket such that the upper feed roll is disposed within the pocket.

10. The wire feeder according to claim 1, wherein the connecting arm includes coaxial apertures in the first and second side surfaces such that the upper feed roll is rotatably coupled to the connecting arm via the apertures.

11. The wire feeder according to claim 1, wherein at least one of the upper feed roll and the lower feed roll include a groove for receiving the wire.

12. The wire feeder according to claim 1, wherein the upper feed roll is flat and the lower feed roll includes a groove for receiving the wire.

13. The wire feeder according to claim 12, wherein the groove is sized to correspond to a size of wire, such that the upper feed roll and the lower feed roll are individual to the wire size.

14. The wire feeder according to claim 1, wherein the lower feed roll is configured to rotate in a clockwise direction in response to the torque being applied by the motor.

15. The wire feeder according to claim 14, wherein the upper feed roll is configured to rotate in a counterclockwise direction in response to the torque being applied by the motor via the arm and the connecting arm.

16. The wire feeder according to claim 1, wherein the lower feed roll is configured to rotate in a counterclockwise direction in response to the torque being applied by the motor.

17. The wire feeder according to claim 16, wherein the upper feed roll is configured to rotate in a clockwise direction in response to the torque being applied by the motor via the arm and the connecting arm.

18. A method for operating a wire feeder for a welding system, the method comprising:
operating a motor including an output motor shaft;
feeding a wire between an upper feed roll and a lower feed roll, the upper feed roll selectively positionable adjacent to the lower feed roll, the lower feed roll being connected to the output motor shaft, a connecting arm being attached to the upper feed roll and pinned to a drivestand at a first end, the connecting arm operable to selectively position the upper feed roll with respect to the lower feed roll;
pivoting an arm between an open position and a clamped position, the arm being pivotably attached to the connecting arm at a second end opposite from the first end, the arm being further coupled to the motor;
applying a torque by the motor to the lower feed roll via the output motor shaft, and the upper feed roll via the arm and the connecting arm; and
generating a clamping force by the arm and the connecting arm in response to the torque being applied by the motor,
wherein the clamping force is proportional to a torque of the motor.

19. The method according to claim 18, wherein the clamping force is automatically generated by the torque, in response to overcoming friction resistance of the wire in the welding system.

20. The method according to claim 19, wherein the clamping force automatically generated by the torque provides a force on the wire being fed through the system.

21. The method according to claim 18, wherein in an open position the connecting arm at the second end is rotated to a position via movement of the arm, such that the upper feed roll is separated from the lower feed roll.

22. The method according to claim 18, further comprising a linkage, the linkage rotationally coupled to the arm at a first pivot point, and a motor mount of the motor at a second pivot point.

23. The method according to claim 22, wherein the arm is rotatably coupled to the connecting arm at a third pivot point, such that movement of the connecting arm is constrained by the first, second, and third pivot points.
